(19) United States
(12) Patent Application Publication
(10) Pub. No.: US 2025/0185103 A1
(43) Pub. Date: Jun. 5, 2025

(54) ENHANCEMENTS FOR INACTIVE STATE IN NEXT GENERATION RADIO ACCESS NETWORKS WITH SERVICE BASED ARCHITECTURE

(71) Applicants: Zongrui Ding, Portland, OR (US); Sudeep Palat, Cheltenham (GB); Qian Li, Portland, OR (US); Alexandre Saso Stojanovski, Paris (FR); Thomas Luetzenkirchen, Taufkirchen (DE); Abhijeet Kolekar, Leander, TX (US); Xiaopeng Tong, Beijing (CN); Richard Burbidge, Shrivenham (GB); Puneet Jain, Portland, OR (US)

(72) Inventors: Zongrui Ding, Portland, OR (US); Sudeep Palat, Cheltenham (GB); Qian Li, Portland, OR (US); Alexandre Saso Stojanovski, Paris (FR); Thomas Luetzenkirchen, Taufkirchen (DE); Abhijeet Kolekar, Leander, TX (US); Xiaopeng Tong, Beijing (CN); Richard Burbidge, Shrivenham (GB); Puneet Jain, Portland, OR (US)

(21) Appl. No.: 19/048,163

(22) Filed: Feb. 7, 2025

Related U.S. Application Data
(60) Provisional application No. 63/551,238, filed on Feb. 8, 2024.

(51) Int. Cl. H04W 76/20; H04W 76/19; H04W 76/30

(52) U.S. Cl. CPC H04W 76/20; H04W 76/19; H04W 76/30

(57) ABSTRACT

Various embodiments herein relate to a user equipment (UE) context management (collectively, “UCM”) function of a cellular network. The UCM may be configured to store an inactive radio network temporary identifier (I-RNTI) and context information related to a UE prior to the UE entering an RRC_INACTIVE state. The UCM may be further configured to provide, based on a request related to an RRC resume procedure of the UE, an indication of the I-RNTI and the context information. Other embodiments may be described and/or claimed.

### CROSS REFERENCE TO RELATED APPLICATION

The present application claims priority to U.S. Provisional Patent Application No. 63/551,238, which was filed Feb. 8, 2024, the disclosure of which is hereby incorporated by reference.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example next generation (NG)-radio access network (RAN) architecture, in accordance with various embodiments.

FIG. 2 illustrates an example centralized unit (CU)/distributed unit (DU) split architecture, in accordance with various embodiments.

FIG. 3 shows an example RAN service based architecture (SBA) reference architecture with split CU-control plane (CP) functions, in accordance with various embodiments.

FIG. 4 shows an example RAN SBA reference architecture with a converged RAN/core network (CN), in accordance with various embodiments.

FIG. 5 shows an example RAN SBA reference architecture with a separate RAN/CN, in accordance with various embodiments.

FIG. 6 shows an example radio resource control (RRC) Release procedure for transitioning to the inactive state with RRC state management at the DU, in accordance with various embodiments.

FIG. 7 shows an example RRC Release procedure for transitioning to the inactive state with RRC state management at the DU, in accordance with various embodiments.

FIG. 8 shows an example RRC resume procedure, in accordance with various embodiments.

FIG. 9 illustrates a network in accordance with various embodiments.

FIG. 10 schematically illustrates a cellular network in accordance with various embodiments.

FIG. 11 is a block diagram illustrating components, according to some example embodiments, able to read instructions from a machine-readable or computer-readable medium (e.g., a non-transitory machine-readable storage medium) and perform any one or more of the methodologies discussed herein.

FIG. 12 illustrates a network in accordance with various embodiments.

FIG. 13 illustrates an example procedure, in accordance with various embodiments.

FIG. 14 illustrates an alternative example procedure, in accordance with various embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B). Unless used differently herein, terms, definitions, and abbreviations may be consistent with terms, definitions, and abbreviations defined in 3GPP TR 21.905 v16.0.0 (2019-06).

The present disclosure is generally related to wireless communication, cellular networks, radio access networks, cloud computing, data centers, network topologies, communication system implementations, and in particular, to inactive state enhancements in NG-RANs with service based architecture (SBA).

### NG-RAN Architecture

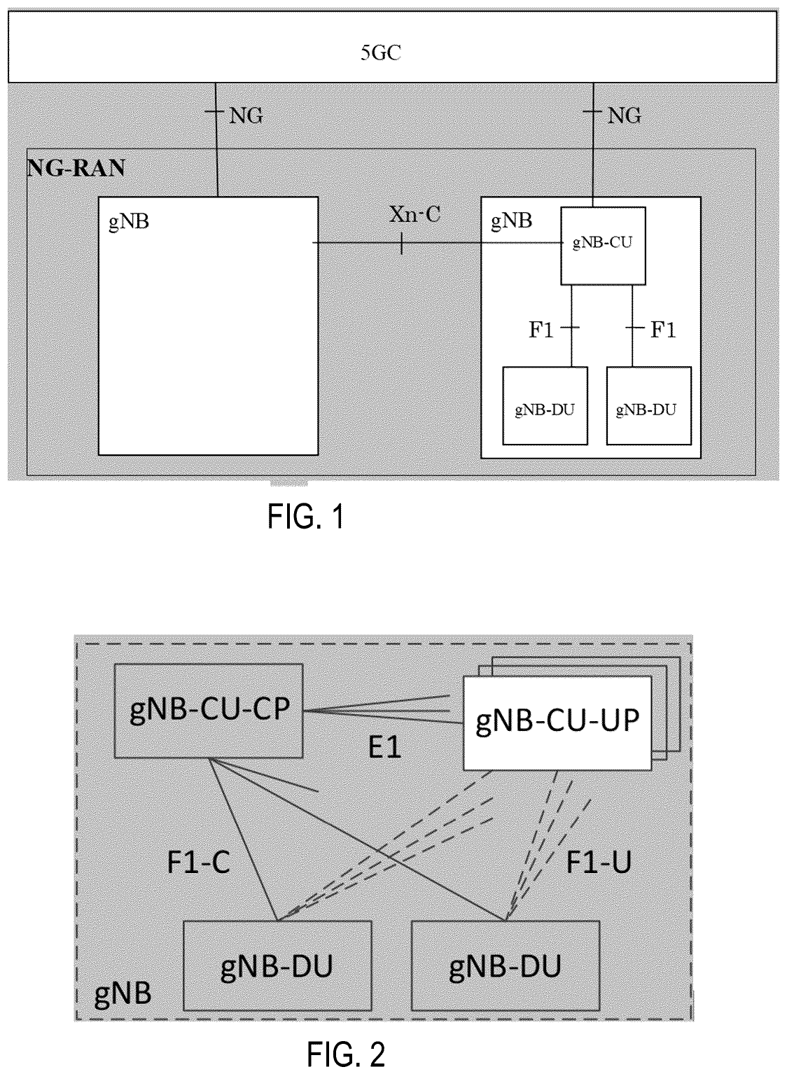

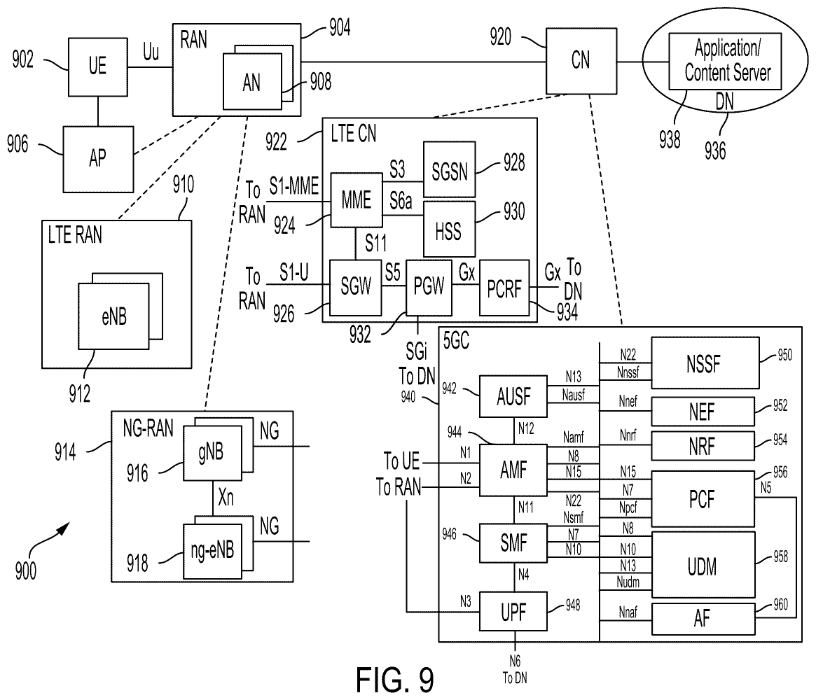

FIG. 1 shows an example NG-RAN architecture. The NG-RAN includes a set of base stations such as gNodeBs (“gNBs”) connected to the fifth generation (5G) core network (5GC) through the next generation (NG) interface. The set of gNBs can be interconnected through an Xn interface. The 5GC, the NG-RAN, and the set of gNBs in FIG. 1 be the same or similar as the 5GC 940, the radio access network (RAN) 904, and the gNBs 916 of FIG. 9, respectively. A gNB can support frequency division duplexed (FDD) mode, time division duplexed (TDD) mode, and/or dual mode operation.

The NG-RAN can employ a CU/DU split architecture (see e.g., the third generation partnership project (3GPP) technical specification (TS) 38.401), where individual gNBs may include a gNB-CU and one or more gNB-DUs (and potentially one or more remote units (RUs)). The gNB-CU is connected to individual gNB-DUs via respective F1 interfaces. In some implementations, one gNB-DU is connected to only one gNB-CU. A gNB-CU may be connected to one or more gNB-DUs. In some examples, for resiliency, a gNB-DU may be connected to multiple gNB-CUs by appropriate implementation.

In some examples, the NG-RAN could additionally or alternatively include a set of ng- eNodeBs (eNBs). The set of ng-eNBs may be the same or similar as the ng-eNBs 918 of FIG. 9. An ng-eNB may include an ng-eNB-CU and one or more ng-eNB-DU(s). An ng-eNB-CU is connected to individual ng-eNB-DUs via respective W1 interfaces. The general principles described with respect to the gNB(s) and the F1 interface can also apply to the ng-eNB(s) and the W1 interface, unless explicitly stated otherwise.

In some examples, in case of network sharing with multiple cell identifier (ID) broadcast(s), each cell identity associated with a subset of public land mobile networks (PLMNs) corresponds to a gNB-DU and the gNB-CU it is connected to (e.g., the corresponding gNB-DUs share the same physical layer cell resources).

The NG, Xn, and F1 are logical interfaces. For NG-RAN, the NG and Xn-C interfaces for a gNB includes a gNB-CU and gNB-DUs, terminate in the gNB-CU. For EN-DC, the S1-U and X2-C interfaces for a gNB including a gNB-CU and gNB-DUs, terminate in the gNB-CU. The gNB-CU and connected gNB-DUs are only visible to other gNBs and the 5GC as a gNB. A possible deployment scenario is described in Annex A of 3GPP TS 38.401.

A node hosting user plane (UP) part of packet data convergence protocol (PDCP) (e.g., gNB-CU, gNB-CU-UP, and for EN-DC, MeNB or SgNB depending on the bearer split) performs user inactivity monitoring and further informs its inactivity or (re)activation to the node having C-plane connection towards the core network (e.g., over E1, X2 interface(s)). The node hosting a new radio (NR) radio link control (RLC) (e.g., a gNB-DU) may perform user inactivity monitoring and further inform its inactivity or (re) activation to the node hosting control plane (CP) (e.g., gNB-CU or gNB-CU-CP).

Uplink (UL) PDCP configuration (e.g., how the user equipment (UE) uses the UL at the assisting node) is indicated via X2-C (for EN-DC), Xn-C (for NG-RAN) and F1-C. Radio Link Outage/Resume for downlink (DL) and/or UL is indicated via X2-U (for EN-DC), Xn-U (for NG-RAN) and F1-U.

The NG-RAN is layered into a Radio Network Layer (RNL) and a Transport Network Layer (TNL). The NG-RAN architecture (e.g., the NG-RAN logical nodes and interfaces between them) is defined as part of the RNL. For each NG-RAN interface (NG, Xn, F1) the related TNL protocol and the functionality are specified. The TNL provides services for UP transport, signaling transport.

In NG-Flex configurations, each NG-RAN node is connected to all access mobility functions (AMFs) of AMF Sets within an AMF Region supporting at least one slice also supported by the NG-RAN node. The AMF Set and the AMF Region are defined, for example, in the 3GPP TS 23.501. If security protection for control plane (CP) and user plane (UP) data on TNL of the NG-RAN interfaces is supported, network domain security (NDS)/internet protocol (IP) is applied (see e.g., 3GPP TS 33.501).

FIG. 2 depicts an example CU/DU split architecture for separation of gNB-CU-CP and gNB-CU-UP. As shown by FIG. 2, a gNB includes a gNB-CU-CP, one or multiple gNB-CU-UPS, and multiple gNB-DUs. The gNB-CU-CP is connected to the gNB-DU through the F1 CP (F1-C) interface. The gNB-CU-UP is connected to the gNB-DU through the F1 UP (F1-U) interface. The gNB-CU-UP is connected to the gNB-CU-CP through the E1 interface. When an NG-RAN includes a set of ng-eNBs, an ng-eNB may include an ng-eNB-CU-CP, one or more ng-eNB-CU-UP(s), and one or more ng-eNB-DU(s). An ng-eNB-CU-CP and an ng-eNB-CU-UP is connected via the E1 interface. An ng-eNB-DU is connected to an ng-eNB-CU-CP via a W1-C interface, and to an ng-eNB-CU-UP via a W1-U interface. The general principles described with respect to the gNB(s) and the F1 interface can also apply to the ng-eNB(s) and W1 interface, unless explicitly stated otherwise.

In some examples, one gNB-DU is connected to only one gNB-CU-CP. Additionally or alternatively, one gNB-CU-UP is connected to only one gNB-CU-CP. In some examples, for resiliency, a gNB-DU and/or a gNB-CU-UP may be connected to multiple gNB-CU-CPs by appropriate implementation. Additionally or alternatively, one gNB-DU can be connected to multiple gNB-CU-UPs under the control of the same gNB-CU-CP. Additionally or alternatively, one gNB-CU-UP can be connected to multiple DUs under the control of the same gNB-CU-CP.

In some examples, the connectivity between a gNB-CU-UP and a gNB-DU is established by the gNB-CU-CP using Bearer Context Management functions. Additionally or alternatively, the gNB-CU-CP selects the appropriate gNB-CU-UP(s) for the requested services for a UE 902. In case of multiple CU-UPs they belong to same security domain as defined in 3GPP TS 33.210. Additionally or alternatively, data forwarding between gNB-CU-UPs during intra-gNB-CU-CP handover within a gNB may be supported by Xn-U.

### RAN SBA Reference Architecture

The 5GC has adopted a service based architecture (SBA) to allow for function modulation and relatively easy implementation by using application program interfaces (APIs) (e.g., RESTful APIs and/or the like) among the various Network Functions (NFs) in the 5GC. In various implementations, the RAN architecture is adapted to include an SBA to allow for function modulation and relatively easy implementation by using APIs (e.g., RESTful APIs and/or some other API(s), such as any of those discussed herein) among various NFs (or RAN functions (RANFs)) in the RAN.

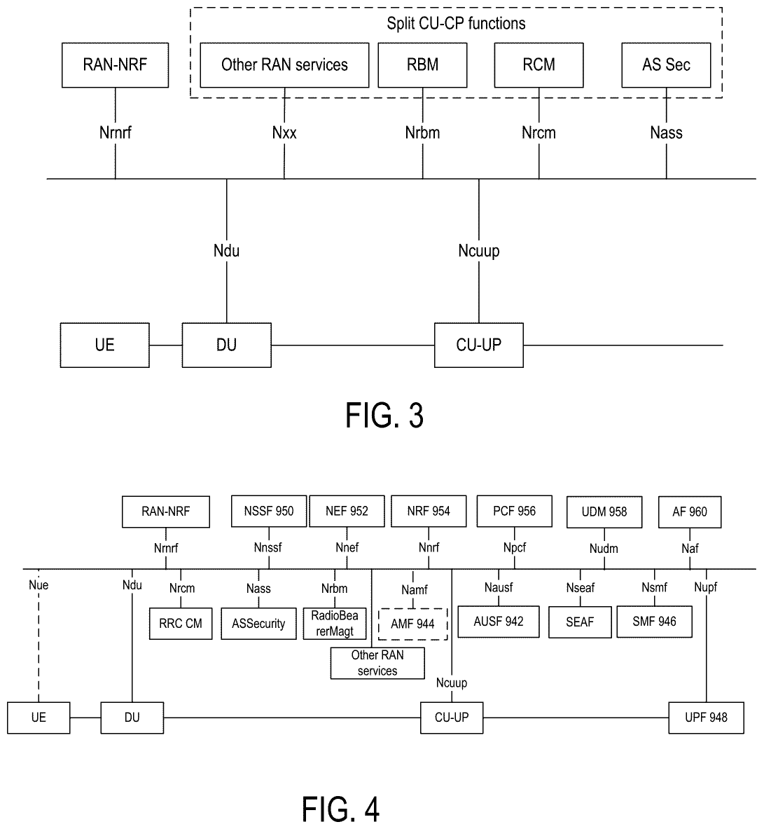

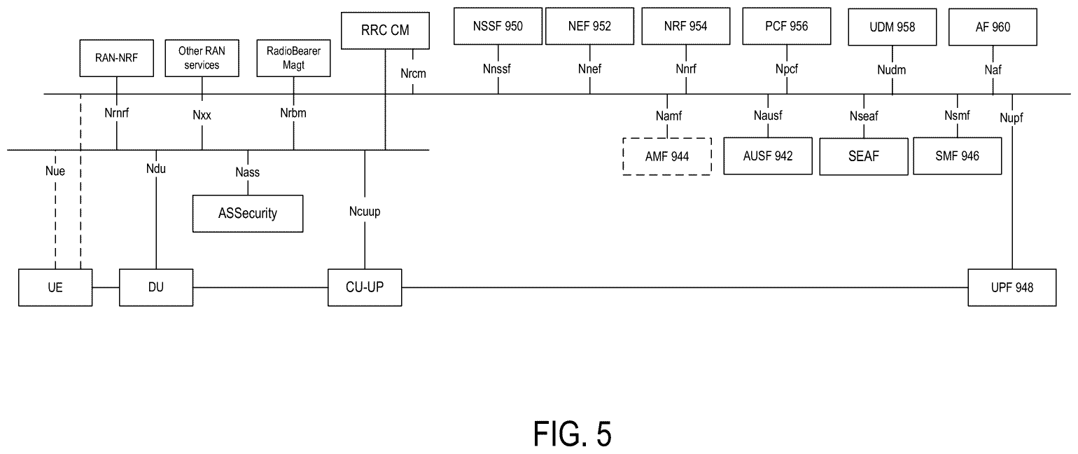

FIG. 3 shows an example radio access network (RAN) service based architecture (SBA) reference architecture with split CU-CP functions; FIG. 4 shows an example RAN SBA reference architecture with a converged RAN/CN; and FIG. 5 shows an example RAN SBA reference architecture with a separate RAN/CN. The RAN SBA allows flexible and scalable RAN implementations where the F1-C transforms into an SBA and/or includes service-based interfaces (SBI). This also allows individual DUs to connect to multiple CU-CPs via one or more SBIs to enable scenarios, such as RAN sharing, RAN slicing, and/or the like.

The RAN includes a DU and CU-UP that connect to the SBA bus via Ndu and Ncuup interfaces, respectively, on user plane. Additionally, the RAN control plane is split into different RAN functions (RANFs). These control plane functions connect to the RAN SBA via respective SBIs. In some examples, the various RANFs connect to the same RAN SBA bus (or multiple RAN SBA buses). The RAN SBA bus can be the same or separate bus with the CN 940. Any of the service buses discussed herein may include any suitable protocol, API, web service, interconnect (IX) technology, and/or any other communication and/or interconnection means, including any of those discussed herein.

In the examples of FIGS. 3, 4, and 5, the RAN functions (RANFs) include a RAN-network reepository function (NRF), one or more DUs, one or more CU-UPs, and one or more CU-CPs. Individual CU-CPs can include a radio bearer management function (RBM), an RRC connection management function (RCM), an access stratum (AS) security function (AS Sec or ASSecurity), and/or other RANFs to provided one or more other RAN services. As examples, the other RANFs can include one or more of: a UE context management function (UCM), remote interference management function (RIM), cross-link interference management function, non-public network (NPN) support function, random access channel (RACH) optimization function, positioning function, NR multicast/broadcast services (MBS) support function, physical cell ID (PCI) optimization function, network energy saving (NES) function, mobility robustness optimization function (MRO), load balancing optimization function (LBO), Capacity and Coverage Optimization (CCO) Function, QoE Measurement Collection function (including RAN visible QoE measurement function and/or the like), Time Sensitive Communications (TSC) function, and/or some other RANF. In some examples, the RAN SBA can include multiple instances of the RANFs. Additionally or alternatively, the association between two or more RANFs (e.g., service consumer and provider) is facilitated by the RAN-Network Repository Function (NRF), which may be similar to the NRF 954 of FIG. 9 (see e.g., 3GPP TS 23.501).

In FIG. 4, the RAN SBA is converged with the CN SBA so that some or all of the RANFs connect to the same bus as the CN SBA. In these implementations, the DU can access other RAN services and/or NF services based on the mobile network operator (MNO) policy through the RAN/CN common SBA bus.

In FIG. 5, the RAN SBA is separate from the CN SBA but there is a common function which connects to both RAN and CN SBA, e.g., RCM. To enable RAN SBA, the RAN Network Repository Function (RAN-NRF) is introduced to maintain a repository of the RAN functions and serves similar purpose for a NRF defined in 23.501 for CN SBA. All the RAN control plane function instances shall register to the RAN-NRF with its supported services to be discovered by other RAN/CN functions based on operators' policy.

The UE in FIGS. 3, 4, and/or 5 may correspond to the UE 902 of FIG. 9. The UE can be either in an RRC_CONNECTED state or in RRC_INACTIVE state when an RRC connection has been established. If this is not the case, such as when no RRC connection is established, the UE is in an RRC_IDLE state.

In RRC_IDLE, a UE specific discontinuous reception (DRX) may be configured by upper layers, and at lower layers, the UE may be configured with a DRX for point-to-multipoint (PTM) transmission of multicast-broadcast services (MBS) broadcast. RRC_IDLE also includes UE controlled mobility based on network configuration. The UE in RRC_IDLE monitors Short Messages transmitted with paging radio network temporary identifier (P-RNTI) over downlink control information (DCI) (see e.g., 3GPP TS 38.331 § 6.5); monitors a Paging channel for CN paging using 5G serving-temporary mobile subscriber identity (S-TMSI), except if the UE is acting as a layer 2 (L2) UE-to-network (U2N) Remote UE; if configured by upper layers for MBS multicast reception, monitors a Paging channel for CN paging using a temporary mobile group identity (TMGI); performs neighboring cell measurements and cell (re-)selection; acquires system information and can send SI request (if configured); performs logging of available measurements together with location and time for logged measurement configured UEs; performs idle/inactive measurements for idle/inactive measurement configured UEs; and if configured by upper layers for MBS broadcast reception, acquires mobile control channel (MCCH) change notification and MBS broadcast control information and data.

In RRC_INACTIVE, a UE specific DRX may be configured by upper layers or by RRC layer, and at lower layers, the UE may be configured with a DRX for PTM transmission of MBS broadcast and/or a DRX for PTM transmission of MBS multicast. RRC_INACTIVE also includes UE controlled mobility based on network configuration. In RRC_INACTIVE, the UE stores the UE Inactive application service (AS) context; a RAN-based notification area is configured by RRC layer; and transfer of unicast data and/or signaling to/from UE over radio bearers configured for small data transmission (SDT). The UE in RRC_INACTIVE monitors Short Messages transmitted with P-RNTI over DCI (see e.g., 3GPP TS 38.331 § 6.5); while T319a is running, monitors control channels associated with the shared data channel to determine if data is scheduled for it; while T319a is not running, monitors a Paging channel for CN paging using 5G-S-TMSI and RAN paging using fullI-RNTI, except if the UE is acting as a L2 U2N Remote UE; if configured by upper layers for MBS multicast reception, while T319a is not running, monitors a Paging channel for paging using TMGI; performs neighboring cell measurements and cell (re-)selection; performs RAN-based notification area updates periodically and when moving outside the configured RAN-based notification area; acquires system information and, while SDT procedure is not ongoing, can send SI request (if configured); while SDT procedure is not ongoing, performs logging of available measurements together with location and time for logged measurement configured UEs; while SDT procedure is not ongoing, performs idle/inactive measurements for idle/inactive measurement configured UEs; if configured by upper layers for MBS broadcast reception, acquires MCCH change notification and MBS broadcast control information and data; if configured for MBS multicast reception in RRC_INACTIVE, acquires multicast MCCH change notification and MBS multicast control information and data; and transmits SRS for Positioning.

In RRC_CONNECTED, the UE stores the AS context; the transfer of unicast data to/from UE takes place; and the transfer of MBS multicast data to UE takes place. At lower layers, the UE may be configured with a UE specific DRX. At lower layers, the UE may be configured with a DRX for PTM transmission of MBS broadcast and/or a DRX for MBS multicast. At lower layers, the UE may be configured with a cell specific cell DTX/DRX. For UEs supporting CA, use of one or more SCells, aggregated with the SpCell, for increased bandwidth. For UEs supporting DC, use of one SCG, aggregated with the MCG, for increased bandwidth. RRC_CONNECTED also includes network controlled mobility within NR, to/from E-UTRA, and to UTRA-FDD; and network controlled mobility (path switch) between a serving cell and a L2 U2N Relay UE, or vice versa. The UE in RRC_CONNECTED monitors Short Messages transmitted with P-RNTI over DCI (see clause 6.5), if configured; monitors control channels associated with the shared data channel to determine if data is scheduled for it; provides channel quality and feedback information; performs neighboring cell measurements and measurement reporting; acquires system information; performs immediate MDT measurement together with available location reporting; and if configured by upper layers for MBS broadcast reception, acquires MCCH change notification and MBS broadcast control information and data.

The RAN SBA brings further split of the RRC functions, which together with CN SBA will allow redundant RAN/CN functions to be removed to simplify signaling. Currently RAN and CN are maintaining separate idle states (e.g., RRC_IDLE and CM_IDLE). In 6G, the idle state removal could be reconsidered to yield simple RRC states: RRC_CONNECTED and RRC_INACTIVE. RRC_INACTIVE state allows both the UE and the network (NW) to store UE's radio configurations to enable UE's fast transfer to RRC_CONNECTED during the RRC resume procedure. According to 3GPP TS 38.331, the network (NW) can send an RRC release message to the UE with SuspendConfig information elements (IEs) to trigger UE going to RRC_INACTIVE instead of RRC_IDLE.

The SuspendConfig IE includes an inactive radio network temporary identifier (I-RNTI), which is used to identify a suspended UE context of a UE in the RRC_INACTIVE state. The NW assigns an I-RNTI to the UE when moving from RRC_CONNECTED to RRC_ INACTIVE in an RRCRelease message within SuspendConfig. The I-RNTI allocated by the NW is used as the identifier in the RRC resume procedure to retrieve the stored UE's context.

Two types of I-RNTIs are defined, including fullI-RNTI and shortI-RNTI. The fullI-RNTI is a bit string of length 40 bits while the shortI-RNTI is a bit string of length 24 bits. In some examples, the NW informs the UE in system information block 1 (SIB1) which I-RNTI is to be used while resuming the connection (e.g., in the RRCResumeRequest message or RRCResumeRequest1 message). The SIB1 can include a useFullResumeID field/IE to indicate which resume identifier and resume request message should be used. The UE uses fullI-RNTI and RRCResumeRequest 1 if the field is present, or shortI-RNTI and RRCResumeRequest if the field is absent. The fullI-RNTI includes the UE's identity as well as the DU's identity. The DU part is used to fast locate the UE's context which is stored in the DU. The current I-RNTI may be reallocated if the UE connects to a different DU due to mobility.

In the context of RAN with SBA (see e.g., U.S. Provisional App. No. 63/594,349 filed 30 Oct. 2023 and U.S. Provisional App. No. 63/591,220 filed 18 Oct. 2023), the UE's context and configurations can be stored in/by a UE context management function (UCM) in the NW (e.g., NG-RAN). This will result in the changes in I-RNTI's allocation and update.

### Discussion of Embodiments

The present disclosure describes various aspects of RRC_INACTIVE state handling and UE context management using a centralized context management function within the RAN SBA. With RAN SBA, the context management can be done via a separate UE Context Management function, which can facilitate the handling of RRC_INACTIVE state. The present disclosure also discusses identifier (e.g., I-RNTI) handling aspects, such as storage and retrieval of the UE context during RRC Release (transitioning to inactive) and RRC Resume procedures. The embodiments discussed herein will enable the cloudification of the RAN, which can be used to reduce network resource consumption and provide additional efficiencies not yet realized in current 3GPP networks.

### RRC Release Aspects

The RRC connection release procedure is used to release the RRC connection, which includes the release of the established radio bearers (except for broadcast MRBs), BH RLC channels, Uu Relay RLC channels, PC5 Relay RLC channels as well as all radio resources; to suspend the RRC connection only if SRB2 and at least one DRB or multicast MRB or, for IAB and NCR, SRB2, are setup, which includes the suspension of the established radio bearers (except for broadcast MRBs); and/or when requested by upper layers, to release the RRC connection and/or bar access to a current PCell.

The NW initiates the RRC connection release procedure to transit a UE in RRC_CONNECTED to RRC_IDLE; to transit a UE in RRC_CONNECTED to RRC_INACTIVE only if SRB2 and at least one DRB or multicast MRB or, for IAB and NCR, SRB2, is setup in RRC_CONNECTED; to transit a UE in RRC_INACTIVE back to RRC_INACTIVE when the UE tries to resume (e.g., for resuming a suspended RRC connection or for initiating SDT); or to transit a UE in RRC_INACTIVE to RRC_IDLE when the UE tries to resume (for resuming of a suspended RRC connection or for initiating SDT). The procedure can also be used to release and redirect a UE to another frequency. The UE initiates the procedure when upper layers request the release of the RRC connection as specified in 3GPP TS 24.501 (“[TS24501]”). The UE does not initiate the procedure for power saving purposes.

In various embodiments, similar to the RRC release procedure defined in 3GPP TS 38.331, the NW sends RRCRelease message to the UE with the SuspendConfig IE and then stores UE context information in the UE context management function. There are two options in terms of whether DU or RCM maintains the RRC states and/or receives triggers for the RRC state change.

### DU Manages RRC States

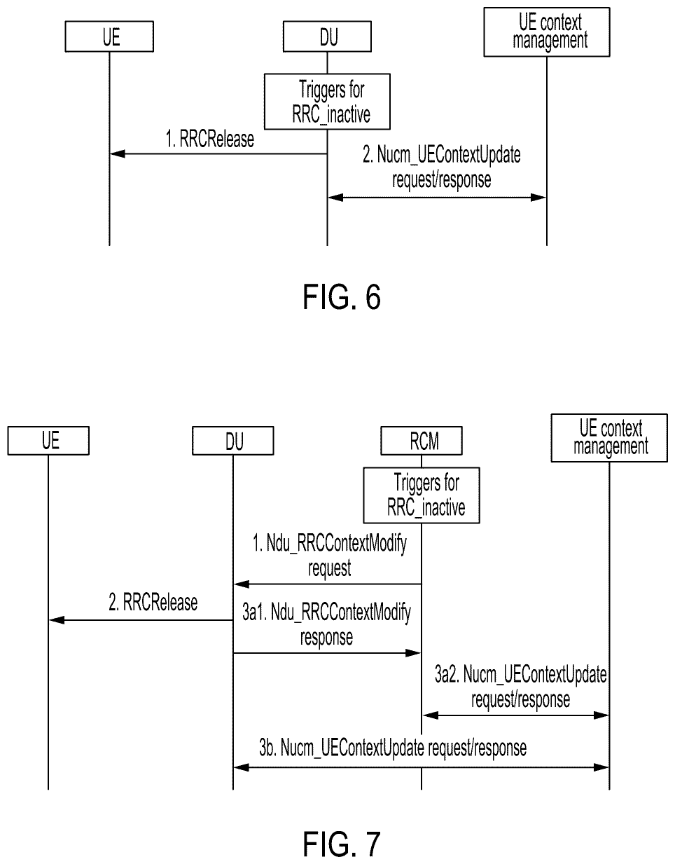

FIG. 6 shows an example RRC Release procedure for transitioning to the inactive state with RRC state management at the DU. In this example, the DU can receive a trigger, such as a timer expiry, after the last data sent to the UE. This can trigger the DU to send a RRCRelease message to the UE. If UE supports RRC inactive state, the DU can decide to include the SuspendConfig IE which can be generated by the DU.

The procedure of FIG. 6 may operate as follows:

In operation 1, the DU sends the RRCRelease message including the SuspendConfig IE. The I-RNTI is the identifier included in the SuspendConfig IE. In various implementations, the I-RNTI is assigned by the RCM or an AMF 944 during initial access and stored in the DU after the UE's context setup. The I-RNTI shall be included in the SuspendConfig IE to as the identifier to be used to retrieve the stored UE's context in the UE context management function (UCM) in the RAN.

At operation 2, the DU sends the Nucm_UEContextUpdate request to the UE context management function to store the UE's I-RNTI, previously attached DU, the UE's context information, such as radio configurations and measurements to be used in RRC resume. At operation 3, the UE context management function sends an Nucm_UEContextUpdate response to the DU to indicate the results of UE's context update.

### RCM Manages RRC States

FIG. 7 shows an example RRC Release procedure for transitioning to the inactive state with RRC state management at the DU. In this example, the DU can receive a trigger, such as a timer expiry, after the last data sent to the UE. This can trigger the DU to send a RRCRelease message to the UE. If UE supports RRC inactive state, the DU can decide to include the SuspendConfig IE which can be generated by the DU.

The procedure of FIG. 7 may operate as follows:

At operation 1, , the RCM sends an Ndu_RRCContextModify request (req) to the DU to request RRCRelease to be sent from the DU when triggered from other source for RRC state change from RRC_CONNECTED to RRC_INACTIVE. In some examples, this message includes the indication of RRC state change from connected to inactive, the state change cause, an optional identifier to be used (e.g., a new I-RNTI allocated due to security reasons, required measurements, and/or the like).

At operation 2, the DU sends an RRCRelease message including the SuspendConfig IE including the I-RNTI, measurements, and radio configurations as described in, for example, 3GPP TS 38.331.

At operation 3a1, the DU sends an Ndu_RRCContextModify response (rsp) to the RCM with the suspendConfig IE. This message can also include the DU's ID.

At operation 3a2, the RCM sends the SuspendConfig and DU ID in an Nucm_UEContextUpdate req to update the UE's context in the UE Context Management function (UCM). In some examples, the UCM can send an Nucm_UEContextUpdate rsp to the RCM based on the Nucm_UEContextUpdate req.

At operation 3b, the DU can update the UE's context information directly by sending an Nucm_UEContextUpdate req to the UCM, which is to cause the UCM to store the UE's context information for RRC_INACTIVE. In some examples, the UCM can send an Nucm_UEContextUpdate rsp to the DU based on the Nucm_UEContextUpdate req. In some examples, operation 3b is performed instead of operations 3a1 and 3a2.

### RRC Resume Aspects

One purpose of the RRC connection resume procedure is to resume a suspended RRC connection, including resuming SRB(s), DRB(s), and multicast MRB(s), to perform an RAN-based Notification Area (RNA) update, and/or to initiate SDT in RRC_INACTIVE.

The RRC connection resume procedure includes the UE sending an RRCResumeRequest msg or RRCResume Request1 msg to the NW. In some examples, the NW sends an RRCResume msg to the UE based on the RRCResumeRequest msg or RRCResumeRequest msg, and the UE sends an RRCResumeComplete msg to the NW. In some examples, the NW sends an RRCSetup msg to the UE based on the RRCResumeRequest msg or RRCResumeRequest1 msg, and the UE sends an RRCSetupComplete msg to the NW. The UE initiates the resume procedure (e.g., transmits the RRCResumeRequest msg or RRCResumeRequest1 msg) when upper layers or access stratum (AS) (when responding to RAN paging, upon triggering RNA updates while the UE is in RRC_INACTIVE, upon requesting multicast reception as specified, for example, in 3GPP TS 38.331 § 5.3.13.1d, for NR sidelink communication/discovery/V2X sidelink communication in § 5.3.13.1a, for NR sidelink positioning in § 5.3.13.1c, for requesting configuration for SRS for positioning, for activation of preconfigured positioning SRS in RRC_INACTIVE, upon receiving RRCRelease message (msg) including resumeIndication) requests the resume of a suspended RRC connection or requests the resume for initiating SDT in § 5.3.13.1b.

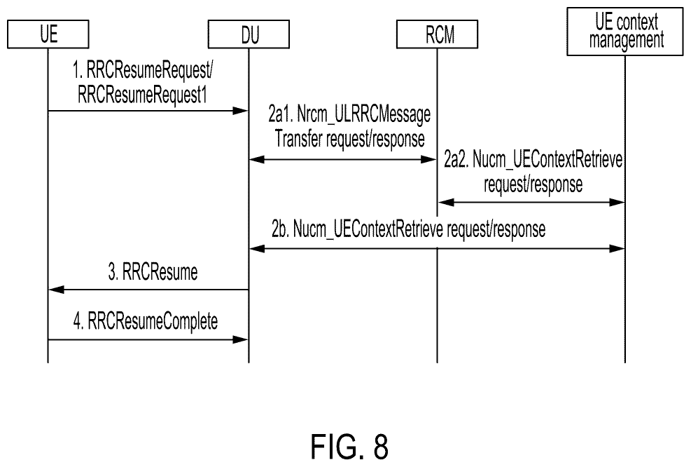

In various embodiments, the UE can send a RRC resume request to the DU to fetch the stored configurations in the UE context management function to the DU to transfer from RRC_inactive to RRC_CONNECTED. FIG. 8 shows an example RRC resume procedure according to such embodiments.

The procedure of FIG. 8 may operate as follows:

At operation 1, the UE sends an RRC resume request (e.g., RRCResumeRequest msg or RRCResumeRequest1 msg) to DU which includes the I-RNTI that previously sent to UE pointing to the stored UE's context during RRC_inactive.

At operation 2a1, if the RRC state is managed in (or by) the RCM, the DU sends an Nrcm_ULRRCMessageTransfer req to the RCM to further resolve the RRC state change with the RRCResumeRequest or RRCResumeRequest1 piggybacked in the HTTP msg. In some examples, the RRCResumeRequest or RRCResumeRequest1 can be encrypted with an RCM key or some other suitable key, such as any of those mentioned herein.

At operation 2a2, the RCM processes the RRCResumeRequest msg or RRCResumeRequest1 msg and sends an Nucm_UEContextRetrieve req to the UE context management function (UCM) to fetch the UE's stored context. In some examples, the stored UE context includes the DU's ID, or the DU ID is otherwise stored in association with the UE context information. Then, the RCM sends the stored UE context in an Nrcm_ULRRCMessage Transfer rsp to the DU. In some examples, the Nrcm_ULRRCMessageTransfer rsp includes the UE's I-RNTI, which could be a current assigned I-RNTI or a newly assigned I-RNTI.

At operation 2b, if the RRC state is managed by the DU, the DU sends an Nucm_UEContextRetrieve req to the UCM to fetch the stored UE's context using the I-RNTI (e.g., long version (fullI-RNTI) or short version (shortI-RNTI)) received in the RRCResumeRequest or RRCResumeRequest1. The UCM verifies the DU's identify and sends the stored UE's context information to the DU.

At operation 3, the DU sends the RRCResume msg to the UE. In some examples, the configurations included in this RRCResume msg can be delta configuration(s) calculated by the DU based on the retrieved UE context. At operation 4, the UE sends an RRCResumeComplete msg similar to the DU in a same or similar manner as specified by 3GPP TS 38.331.

### (Re-) Allocation OF I-RNTI

As mentioned previously, the I-RNTI can be allocated by the RCM or the AMF 944 during the initial access procedure or service request, which will be stored as part of the UE's context information in the UE's context management as well as the DU. With a DU change (e.g., handover, cell (re)selection, and/or the like), the I-RNTI can be reallocated or kept unchanged. Due to security reasons, the I-RNTI can be re-allocated periodically or triggered by other related events or relevant events. Upon receiving a notification of I-RNTI change of a UE, the DU may not need to immediately notify the UE of the I-RNTI change, and instead can notify the UE when the UE is ready to enter RRC_INACTIVE.

### EXAMPLE SYSTEMS

FIGS. 9-12 illustrate various systems, devices, and components that may implement aspects of disclosed embodiments.

FIG. 9 illustrates a network 900 in accordance with various embodiments. The network 900 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 900 may include a UE 902, which may include any mobile or non-mobile computing device designed to communicate with a RAN 904 via an over-the-air connection. The UE 902 may be communicatively coupled with the RAN 904 by a Uu interface. The UE 902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 902 may additionally communicate with an AP 906 via an over-the-air connection. The AP 906 may manage a WLAN connection, which may serve to offload some/all network traffic from the RAN 904. The connection between the UE 902 and the AP 906 may be consistent with any IEEE 802.11 protocol, wherein the AP 906 could be a wireless fidelity (Wi-Fi®) router. In some embodiments, the UE 902, RAN 904, and AP 906 may utilize cellular-WLAN aggregation (for example, LWA/LWIP). Cellular-WLAN aggregation may involve the UE 902 being configured by the RAN 904 to utilize both cellular radio resources and WLAN resources.

The RAN 904 may include one or more access nodes, for example, AN 908. AN 908 may terminate air-interface protocols for the UE 902 by providing access stratum protocols including RRC, PDCP, RLC, MAC, and L1 protocols. In this manner, the AN 908 may enable data/voice connectivity between CN 920 and the UE 902. In some embodiments, the AN 908 may be implemented in a discrete device or as one or more software entities running on server computers as part of, for example, a virtual network, which may be referred to as a CRAN or virtual baseband unit pool. The AN 908 be referred to as a BS, gNB, RAN node, eNB, ng-eNB, NodeB, RSU, TRxP, TRP, etc. The AN 908 may be a macrocell base station or a low power base station for providing femtocells, picocells or other like cells having smaller coverage areas, smaller user capacity, or higher bandwidth compared to macrocells.

In embodiments in which the RAN 904 includes a plurality of ANs, they may be coupled with one another via an X2 interface (if the RAN 904 is an LTE RAN) or an Xn interface (if the RAN 904 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 904 may each manage one or more cells, cell groups, component carriers, etc. to provide the UE 902 with an air interface for network access. The UE 902 may be simultaneously connected with a plurality of cells provided by the same or different ANs of the RAN 904. For example, the UE 902 and RAN 904 may use carrier aggregation to allow the UE 902 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 904 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 902 or AN 908 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 904 may be an LTE RAN 910 with eNBs, for example, eNB 912. The LTE RAN 910 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 904 may be an NG-RAN 914 with gNBs, for example, gNB 916, or ng-eNBs, for example, ng-eNB 918. The gNB 916 may connect with 5G-enabled UEs using a 5G NR interface. The gNB 916 may connect with a 5G core through an NG interface, which may include an N2 interface or an N3 interface. The ng-eNB 918 may also connect with the 5G core through an NG interface, but may connect with a UE via an LTE air interface. The gNB 916 and the ng-eNB 918 may connect with each other over an Xn interface.

In some embodiments, the NG interface may be split into two parts, an NG user plane (NG-U) interface, which carries traffic data between the nodes of the NG-RAN 914 and a UPF 948 (e.g., N3 interface), and an NG control plane (NG-C) interface, which is a signaling interface between the nodes of the NG-RAN 914 and an AMF 944 (e.g., N2 interface).

The NG-RAN 914 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHZ. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 902 can be configured with multiple BWPs where each BWP configuration has a different SCS. When a BWP change is indicated to the UE 902, the SCS of the transmission is changed as well. Another use case example of BWP is related to power saving. In particular, multiple BWPs can be configured for the UE 902 with different amount of frequency resources (for example, PRBs) to support data transmission under different traffic loading scenarios. A BWP containing a smaller number of PRBs can be used for data transmission with small traffic load while allowing power saving at the UE 902 and in some cases at the gNB 916. A BWP containing a larger number of PRBs can be used for scenarios with higher traffic load.

The RAN 904 is communicatively coupled to CN 920 that includes network elements to provide various functions to support data and telecommunications services to customers/subscribers (for example, users of UE 902). The components of the CN 920 may be implemented in one physical node or separate physical nodes. In some embodiments, NFV may be utilized to virtualize any or all of the functions provided by the network elements of the CN 920 onto physical compute/storage resources in servers, switches, etc. A logical instantiation of the CN 920 may be referred to as a network slice, and a logical instantiation of a portion of the CN 920 may be referred to as a network sub-slice.

In some embodiments, the CN 920 may be an LTE CN 922, which may also be referred to as an EPC. The LTE CN 922 may include MME 924, SGW 926, SGSN 928, HSS 930, PGW 932, and PCRF 934 coupled with one another over interfaces (or “reference points”) as shown. Functions of the elements of the LTE CN 922 may be briefly introduced as follows.

The MME 924 may implement mobility management functions to track a current location of the UE 902 to facilitate paging, bearer activation/deactivation, handovers, gateway selection, authentication, etc.

The SGW 926 may terminate an S1 interface toward the RAN and route data packets between the RAN and the LTE CN 922. The SGW 926 may be a local mobility anchor point for inter-RAN node handovers and also may provide an anchor for inter-3GPP mobility. Other responsibilities may include lawful intercept, charging, and some policy enforcement.

The SGSN 928 may track a location of the UE 902 and perform security functions and access control. In addition, the SGSN 928 may perform inter-EPC node signaling for mobility between different RAT networks; PDN and S-GW selection as specified by MME 924; MME selection for handovers; etc. The S3 reference point between the MME 924 and the SGSN 928 may enable user and bearer information exchange for inter-3GPP access network mobility in idle/active states.

The HSS 930 may include a database for network users, including subscription-related information to support the network entities' handling of communication sessions. The HSS 930 can provide support for routing/roaming, authentication, authorization, naming/addressing resolution, location dependencies, etc. An S6a reference point between the HSS 930 and the MME 924 may enable transfer of subscription and authentication data for authenticating/authorizing user access to the LTE CN 920.

The PGW 932 may terminate an SGi interface toward a data network (DN) 936 that may include an application/content server 938. The PGW 932 may route data packets between the LTE CN 922 and the data network 936. The PGW 932 may be coupled with the SGW 926 by an S5 reference point to facilitate user plane tunneling and tunnel management. The PGW 932 may further include a node for policy enforcement and charging data collection (for example, PCEF). Additionally, the SGi reference point between the PGW 932 and the data network 936 may be an operator external public, a private PDN, or an intra-operator packet data network, for example, for provision of IMS services. The PGW 932 may be coupled with a PCRF 934 via a Gx reference point.

The PCRF 934 is the policy and charging control element of the LTE CN 922. The PCRF 934 may be communicatively coupled to the app/content server 938 to determine appropriate QoS and charging parameters for service flows. The PCRF 932 may provision associated rules into a PCEF (via Gx reference point) with appropriate TFT and QCI.

In some embodiments, the CN 920 may be a 5GC 940. The 5GC 940 may include an AUSF 942, AMF 944, SMF 946, UPF 948, NSSF 950, NEF 952, NRF 954, PCF 956, UDM 958, and AF 960 coupled with one another over interfaces (or “reference points”) as shown. Functions of the elements of the 5GC 940 may be briefly introduced as follows.

The AUSF 942 may store data for authentication of UE 902 and handle authentication- related functionality. The AUSF 942 may facilitate a common authentication framework for various access types. In addition to communicating with other elements of the 5GC 940 over reference points as shown, the AUSF 942 may exhibit an Nausf service-based interface.

The AMF 944 may allow other functions of the 5GC 940 to communicate with the UE 902 and the RAN 904 and to subscribe to notifications about mobility events with respect to the UE 902. The AMF 944 may be responsible for registration management (for example, for registering UE 902), connection management, reachability management, mobility management, lawful interception of AMF-related events, and access authentication and authorization. The AMF 944 may provide transport for SM messages between the UE 902 and the SMF 946, and act as a transparent proxy for routing SM messages. AMF 944 may also provide transport for SMS messages between UE 902 and an SMSF. AMF 944 may interact with the AUSF 942 and the UE 902 to perform various security anchor and context management functions. Furthermore, AMF 944 may be a termination point of a RAN CP interface, which may include or be an N2 reference point between the RAN 904 and the AMF 944; and the AMF 944 may be a termination point of NAS (N1) signaling, and perform NAS ciphering and integrity protection. AMF 944 may also support NAS signaling with the UE 902 over an N3 IWF interface.

The SMF 946 may be responsible for SM (for example, session establishment, tunnel management between UPF 948 and AN 908); UE IP address allocation and management (including optional authorization); selection and control of UP function; configuring traffic steering at UPF 948 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 944 over N2 to AN 908; and determining SSC mode of a session. SM may refer to management of a PDU session, and a PDU session or “session” may refer to a PDU connectivity service that provides or enables the exchange of PDUs between the UE 902 and the data network 936.

The UPF 948 may act as an anchor point for intra-RAT and inter-RAT mobility, an external PDU session point of interconnect to data network 936, and a branching point to support multi-homed PDU session. The UPF 948 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 948 may include an uplink classifier to support routing traffic flows to a data network.

The NSSF 950 may select a set of network slice instances serving the UE 902. The NSSF 950 may also determine allowed NSSAI and the mapping to the subscribed S-NSSAIs, if needed. The NSSF 950 may also determine the AMF set to be used to serve the UE 902, or a list of candidate AMFs based on a suitable configuration and possibly by querying the NRF 954. The selection of a set of network slice instances for the UE 902 may be triggered by the AMF 944 with which the UE 902 is registered by interacting with the NSSF 950, which may lead to a change of AMF. The NSSF 950 may interact with the AMF 944 via an N22 reference point; and may communicate with another NSSF in a visited network via an N31 reference point (not shown). Additionally, the NSSF 950 may exhibit an Nnssf service-based interface.

The NEF 952 may securely expose services and capabilities provided by 3GPP network functions for third party, internal exposure/re-exposure, AFs (e.g., AF 960), edge computing or fog computing systems, etc. In such embodiments, the NEF 952 may authenticate, authorize, or throttle the AFs. NEF 952 may also translate information exchanged with the AF 960 and information exchanged with internal network functions. For example, the NEF 952 may translate between an AF-Service-Identifier and an internal 5GC information. NEF 952 may also receive information from other NFs based on exposed capabilities of other NFs. This information may be stored at the NEF 952 as structured data, or at a data storage NF using standardized interfaces. The stored information can then be re-exposed by the NEF 952 to other NFs and AFs, or used for other purposes such as analytics. Additionally, the NEF 952 may exhibit an Nnef service-based interface.

The NRF 954 may support service discovery functions, receive NF discovery requests from NF instances, and provide the information of the discovered NF instances to the NF instances. NRF 954 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 954 may exhibit the Nnrf service-based interface.

The PCF 956 may provide policy rules to control plane functions to enforce them, and may also support unified policy framework to govern network behavior. The PCF 956 may also implement a front end to access subscription information relevant for policy decisions in a UDR of the UDM 958. In addition to communicating with functions over reference points as shown, the PCF 956 exhibit an Npcf service-based interface.

The UDM 958 may handle subscription-related information to support the network entities' handling of communication sessions, and may store subscription data of UE 902. For example, subscription data may be communicated via an N8 reference point between the UDM 958 and the AMF 944. The UDM 958 may include two parts, an application front end and a UDR. The UDR may store subscription data and policy data for the UDM 958 and the PCF 956, and/or structured data for exposure and application data (including PFDs for application detection, application request information for multiple UEs 902) for the NEF 952. The Nudr service-based interface may be exhibited by the UDR 221 to allow the UDM 958, PCF 956, and NEF 952 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 958 may exhibit the Nudm service-based interface.

The AF 960 may provide application influence on traffic routing, provide access to NEF, and interact with the policy framework for policy control.

In some embodiments, the 5GC 940 may enable edge computing by selecting operator/3rd party services to be geographically close to a point that the UE 902 is attached to the network. This may reduce latency and load on the network. To provide edge-computing implementations, the 5GC 940 may select a UPF 948 close to the UE 902 and execute traffic steering from the UPF 948 to data network 936 via the N6 interface. This may be based on the UE subscription data, UE location, and information provided by the AF 960. In this way, the AF 960 may influence UPF (re)selection and traffic routing. Based on operator deployment, when AF 960 is considered to be a trusted entity, the network operator may permit AF 960 to interact directly with relevant NFs. Additionally, the AF 960 may exhibit an Naf service-based interface.

The data network 936 may represent various network operator services, Internet access, or third party services that may be provided by one or more servers including, for example, application/content server 938.

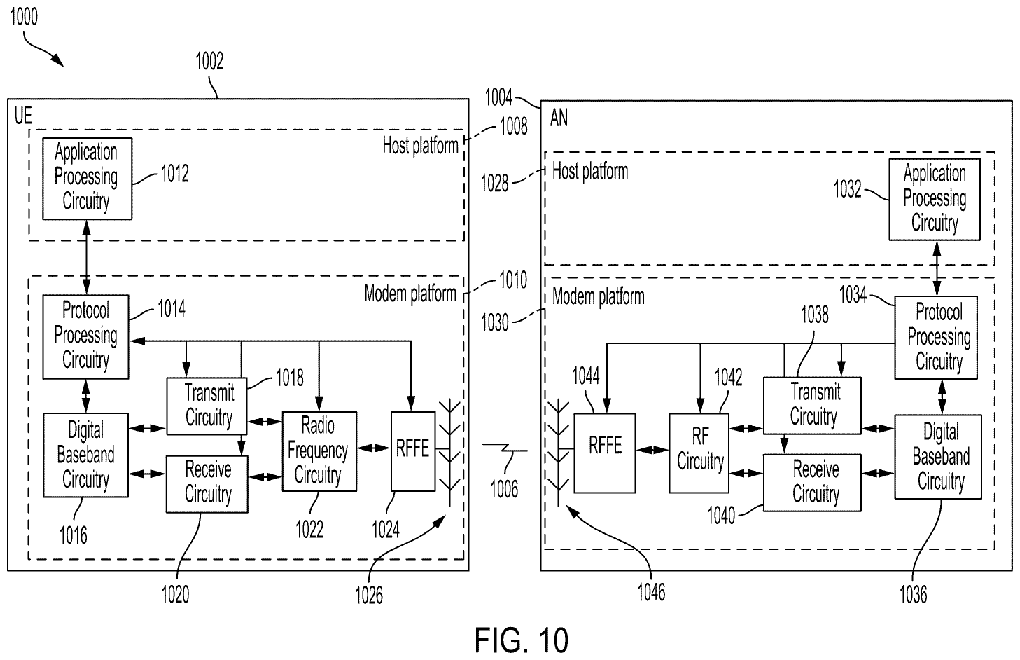

FIG. 10 schematically illustrates a cellular network 1000 in accordance with various embodiments. The cellular network 1000 may include a UE 1002 in wireless communication with an AN 1004. The UE 1002 and AN 1004 may be similar to, and substantially interchangeable with, like-named components described elsewhere herein.

The UE 1002 may be communicatively coupled with the AN 1004 via connection 1006. The connection 1006 is illustrated as an air interface to enable communicative coupling, and can be consistent with cellular communications protocols such as an LTE protocol or a 5G NR protocol operating at mm Wave or sub-6GHZ frequencies.

The UE 1002 may include a host platform 1008 coupled with a modem platform 1010. The host platform 1008 may include application processing circuitry 1012, which may be coupled with protocol processing circuitry 1014 of the modem platform 1010. The application processing circuitry 1012 may run various applications for the UE 1002 that source/sink application data. The application processing circuitry 1012 may further implement one or more layer operations to transmit/receive application data to/from a data network. These layer operations may include transport (for example UDP) and Internet (for example, IP) operations

The protocol processing circuitry 1014 may implement one or more of layer operations to facilitate transmission or reception of data over the connection 1006. The layer operations implemented by the protocol processing circuitry 1014 may include, for example, MAC, RLC, PDCP, RRC and NAS operations.

The modem platform 1010 may further include digital baseband circuitry 1016 that may implement one or more layer operations that are “below” layer operations performed by the protocol processing circuitry 1014 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1010 may further include transmit circuitry 1018, receive circuitry 1020, RF circuitry 1022, and RF front end (RFFE) 1024, which may include or connect to one or more antenna panels 1026. Briefly, the transmit circuitry 1018 may include a digital-to-analog converter, mixer, intermediate frequency (IF) components, etc.; the receive circuitry 1020 may include an analog-to-digital converter, mixer, IF components, etc.; the RF circuitry 1022 may include a low-noise amplifier, a power amplifier, power tracking components, etc.; RFFE 1024 may include filters (for example, surface/bulk acoustic wave filters), switches, antenna tuners, beamforming components (for example, phase-array antenna components), etc. The selection and arrangement of the components of the transmit circuitry 1018, receive circuitry 1020, RF circuitry 1022, RFFE 1024, and antenna panels 1026 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1014 may include one or more instances of control circuitry (not shown) to provide control functions for the transmit/receive components.

A UE reception may be established by and via the antenna panels 1026, RFFE 1024, RF circuitry 1022, receive circuitry 1020, digital baseband circuitry 1016, and protocol processing circuitry 1014. In some embodiments, the antenna panels 1026 may receive a transmission from the AN 1004 by receive-beamforming signals received by a plurality of antennas/antenna elements of the one or more antenna panels 1026.

A UE transmission may be established by and via the protocol processing circuitry 1014, digital baseband circuitry 1016, transmit circuitry 1018, RF circuitry 1022, RFFE 1024, and antenna panels 1026. In some embodiments, the transmit components of the UE 1004 may apply a spatial filter to the data to be transmitted to form a transmit beam emitted by the antenna elements of the antenna panels 1026.

Similar to the UE 1002, the AN 1004 may include a host platform 1028 coupled with a modem platform 1030. The host platform 1028 may include application processing circuitry 1032 coupled with protocol processing circuitry 1034 of the modem platform 1030. The modem platform may further include digital baseband circuitry 1036, transmit circuitry 1038, receive circuitry 1040, RF circuitry 1042, RFFE circuitry 1044, and antenna panels 1046. The components of the AN 1004 may be similar to and substantially interchangeable with like-named components of the UE 1002. In addition to performing data transmission/reception as described above, the components of the AN 1008 may perform various logical functions that include, for example, RNC functions such as radio bearer management, uplink and downlink dynamic radio resource management, and data packet scheduling.

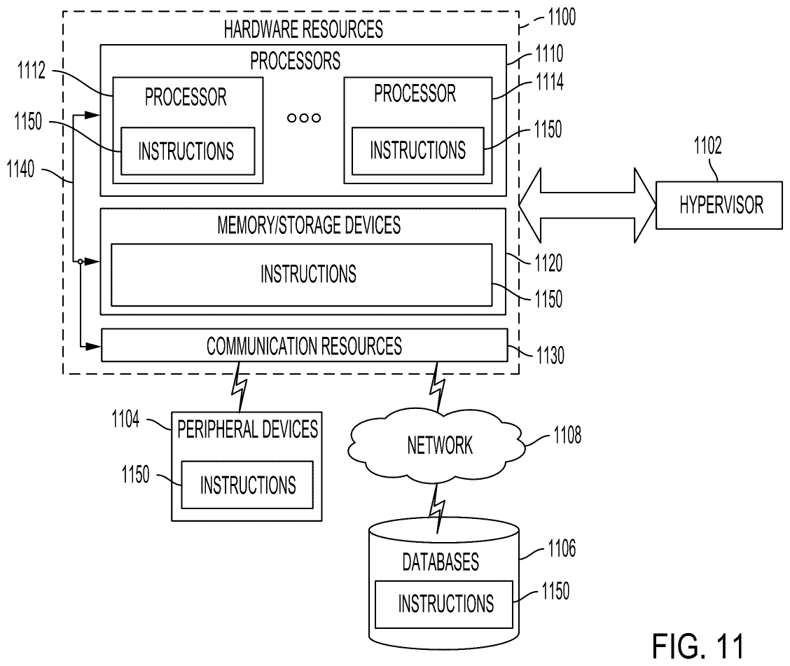

FIG. 11 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1120, and one or more communication resources 1130, each of which may be communicatively coupled via a bus 1140 or other interface circuitry. For embodiments where node virtualization (e.g., NFV) is utilized, a hypervisor 1102 may be executed to provide an execution environment for one or more network slices/sub-slices to utilize the hardware resources 1100.

The processors 1110 may include, for example, a processor 1112 and a processor 1114. The processors 1110 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1120 may include main memory, disk storage, or any suitable combination thereof. The memory/storage devices 1120 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1130 may include interconnection or network interface controllers, components, or other suitable devices to communicate with one or more peripheral devices 1104 or one or more databases 1106 or other network elements via a network 1108. For example, the communication resources 1130 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1150 may comprise software, a program, an application, an applet, an app, or other executable code for causing at least any of the processors 1110 to perform any one or more of the methodologies discussed herein. The instructions 1150 may reside, completely or partially, within at least one of the processors 1110 (e.g., within the processor's cache memory), the memory/storage devices 1120, or any suitable combination thereof. Furthermore, any portion of the instructions 1150 may be transferred to the hardware resources 1100 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

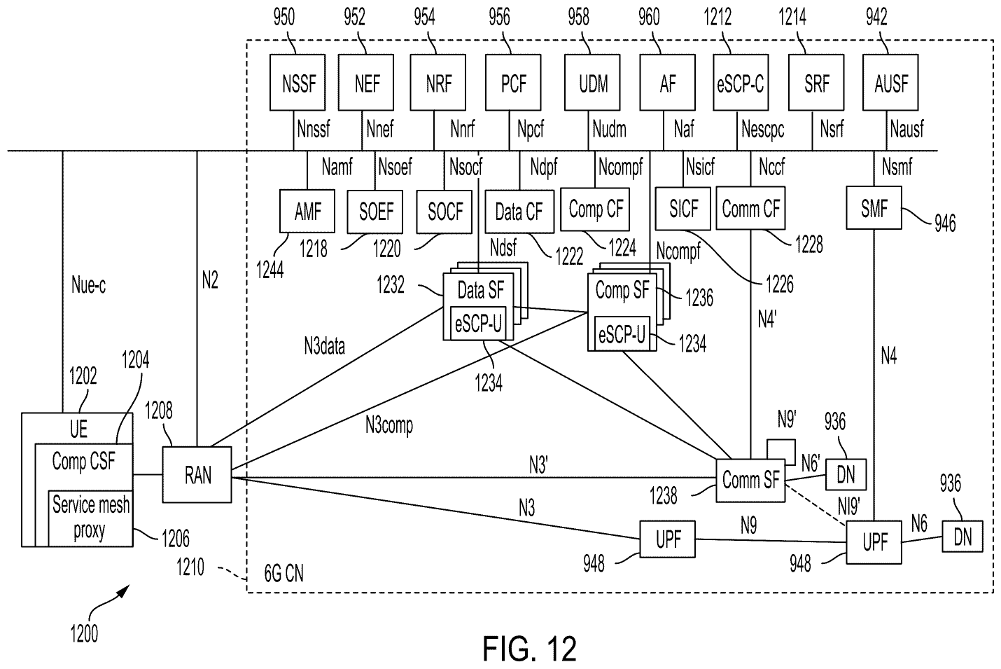

FIG. 12 illustrates a network 1200 in accordance with various embodiments. The network 1200 may operate in a matter consistent with 3GPP technical specifications or technical reports for 6G systems. In some embodiments, the network 1200 may operate concurrently with network 900. For example, in some embodiments, the network 1200 may share one or more frequency or bandwidth resources with network 900. As one specific example, a UE (e.g., UE 1202) may be configured to operate in both network 1200 and network 900. Such configuration may be based on a UE including circuitry configured for communication with frequency and bandwidth resources of both networks 900 and 1200. In general, several elements of network 1200 may share one or more characteristics with elements of network 900. For the sake of brevity and clarity, such clements may not be repeated in the description of network 1200.

The network 1200 may include a UE 1202, which may include any mobile or non-mobile computing device designed to communicate with a RAN 1208 via an over-the-air connection. The UE 1202 may be similar to, for example, UE 902. The UE 1202 may be, but is not limited to, a smartphone, tablet computer, wearable computer device, desktop computer, laptop computer, in- vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 12, in some embodiments the network 1200 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 12, the UE 1202 may be communicatively coupled with an AP such as AP 906 as described with respect to FIG. 9. Additionally, although not specifically shown in FIG. 12, in some embodiments the RAN 1208 may include one or more ANss such as AN 908 as described with respect to FIG. 9. The RAN 1208 and/or the AN of the RAN 1208 may be referred to as a base station (BS), a RAN node, or using some other term or name.

The UE 1202 and the RAN 1208 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 1208 may allow for communication between the UE 1202 and a 6G core network (CN) 1210. Specifically, the RAN 1208 may facilitate the transmission and reception of data between the UE 1202 and the 6G CN 1210. The 6G CN 1210 may include various functions such as NSSF 950, NEF 952, NRF 954, PCF 956, UDM 958, AF 960, SMF 946, and AUSF 942. The 6G CN 1210 may additional include UPF 948 and DN 936 as shown in FIG. 12.

Additionally, the RAN 1208 may include various additional functions that are in addition to, or alternative to, functions of a legacy cellular network such as a 4G or 5G network. Two such functions may include a Compute Control Function (Comp CF) 1224 and a Compute Service Function (Comp SF) 1236. The Comp CF 1224 and the Comp SF 1236 may be parts or functions of the Computing Service Plane. Comp CF 1224 may be a control plane function that provides functionalities such as management of the Comp SF 1236, computing task context generation and management (e.g., create, read, modify, delete), interaction with the underlying computing infrastructure for computing resource management, etc. Comp SF 1236 may be a user plane function that serves as the gateway to interface computing service users (such as UE 1202) and computing nodes behind a Comp SF instance. Some functionalities of the Comp SF 1236 may include: parse computing service data received from users to compute tasks executable by computing nodes; hold service mesh ingress gateway or service API gateway; service and charging policies enforcement; performance monitoring and telemetry collection, etc. In some embodiments, a Comp SF 1236 instance may serve as the user plane gateway for a cluster of computing nodes. A Comp CF 1224 instance may control one or more Comp SF 1236 instances.

Two other such functions may include a Communication Control Function (Comm CF) 1228 and a Communication Service Function (Comm SF) 1238, which may be parts of the Communication Service Plane. The Comm CF 1228 may be the control plane function for managing the Comm SF 1238, communication sessions creation/configuration/releasing, and managing communication session context. The Comm SF 1238 may be a user plane function for data transport. Comm CF 1228 and Comm SF 1238 may be considered as upgrades of SMF 946 and UPF 948, which were described with respect to a 5G system in FIG. 9. The upgrades provided by the Comm CF 1228 and the Comm SF 1238 may enable service-aware transport. For legacy (e.g., 4G or 5G) data transport, SMF 946 and UPF 948 may still be used.

Two other such functions may include a Data Control Function (Data CF) 1222 and Data Service Function (Data SF) 1232 may be parts of the Data Service Planc. Data CF 1222 may be a control plane function and provides functionalities such as Data SF 1232 management, Data service creation/configuration/releasing, Data service context management, etc. Data SF 1232 may be a user plane function and serve as the gateway between data service users (such as UE 1202 and the various functions of the 6G CN 1210) and data service endpoints behind the gateway. Specific functionalities may include include: parse data service user data and forward to corresponding data service endpoints, generate charging data, report data service status.

Another such function may be the Service Orchestration and Chaining Function (SOCF) 1220, which may discover, orchestrate and chain up communication/computing/data services provided by functions in the network. Upon receiving service requests from users, SOCF 1220 may interact with one or more of Comp CF 1224, Comm CF 1228, and Data CF 1222 to identify Comp SF 1236, Comm SF 1238, and Data SF 1232 instances, configure service resources, and generate the service chain, which could contain multiple Comp SF 1236, Comm SF 1238, and Data SF 1232 instances and their associated computing endpoints. Workload processing and data movement may then be conducted within the generated service chain. The SOCF 1220 may also responsible for maintaining, updating, and releasing a created service chain.

Another such function may be the service registration function (SRF) 1214, which may act as a registry for system services provided in the user plane such as services provided by service endpoints behind Comp SF 1236 and Data SF 1232 gateways and services provided by the UE 1202. The SRF 1214 may be considered a counterpart of NRF 954, which may act as the registry for network functions.

Other such functions may include an evolved service communication proxy (eSCP) and service infrastructure control function (SICF) 1226, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 1212 and eSCP-U 1234, for control plane service communication proxy and user plane service communication proxy, respectively. The SICF 1226 may control and configure eCSP instances in terms of service traffic routing policies, access rules, load balancing configurations, performance monitoring, etc.

Another such function is the AMF 1244. The AMF 1244 may be similar to 944, but with additional functionality. Specifically, the AMF 1244 may include potential functional repartition, such as move the message forwarding functionality from the AMF 1244 to the RAN 1208.

Another such function is the service orchestration exposure function (SOEF) 1218. The SOEF may be configured to expose service orchestration and chaining services to external users such as applications.

The UE 1202 may include an additional function that is referred to as a computing client service function (comp CSF) 1204. The comp CSF 1204 may have both the control plane functionalities and user plane functionalities, and may interact with corresponding network side functions such as SOCF 1220, Comp CF 1224, Comp SF 1236, Data CF 1222, and/or Data SF 1232 for service discovery, request/response, compute task workload exchange, etc. The Comp CSF 1204 may also work with network side functions to decide on whether a computing task should be run on the UE 1202, the RAN 1208, and/or an element of the 6G CN 1210.

The UE 1202 and/or the Comp CSF 1204 may include a service mesh proxy 1206. The service mesh proxy 1206 may act as a proxy for service-to-service communication in the user plane. Capabilities of the service mesh proxy 1206 may include one or more of addressing, security, load balancing, etc.

### Example Procedures

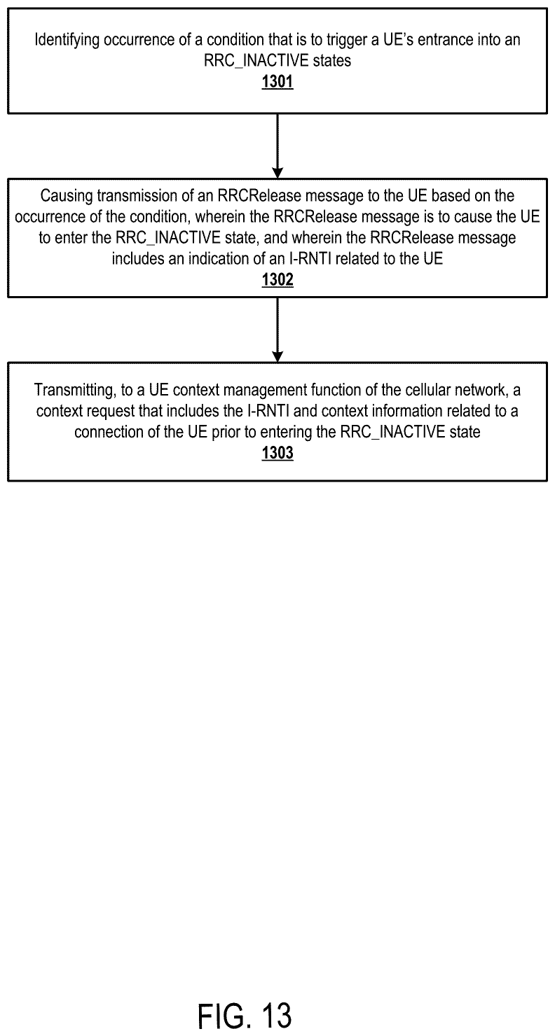

In some embodiments, the electronic device(s), network(s), system(s), chip(s) or component(s), or portions or implementations thereof, of FIGS. 9-12, or some other figure herein, may be configured to perform one or more processes, techniques, or methods as described herein, or portions thereof. One such process is depicted in FIG. 13. The process of FIG. 13 may include or relate to a method to be performed by one or more elements of a cellular network, and/or one or more electronic devices that include and/or implement the one or more elements of the cellular network. In some embodiments, the one or more elements may be or include a DU and/or a RCM function. The process may relate to or include identifying, at 1301, occurrence of a condition that is to trigger a user equipment's (UE's) entrance into an RRC_INACTIVE state; causing, at 1302, transmission of an RRCRelease message to the UE based on the occurrence of the condition, wherein the RRCRelease message is to cause the UE to enter the RRC_INACTIVE state, and wherein the RRCRelease message includes an indication of an inactive radio network temporary identifier (I-RNTI) related to the UE; and transmitting, at 1303 to a UE context management function of the cellular network, a context request that includes the I-RNTI and context information related to a connection of the UE prior to entering the RRC_INACTIVE state.

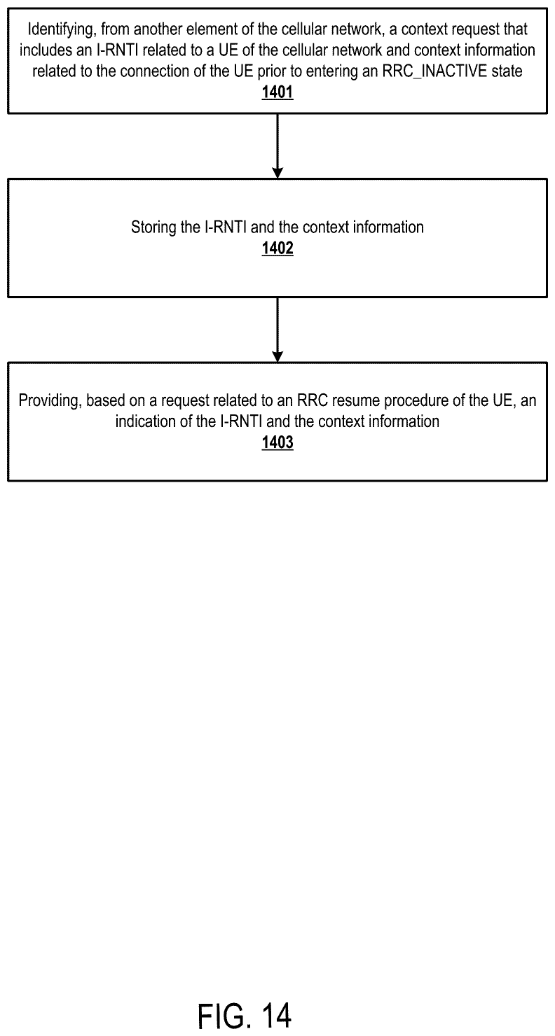

Another such process is depicted in FIG. 14. The process of FIG. 14 may include or relate to a method to be performed by a UCM function of a cellular network and/or one or more electronic devices that include and/or implement the UCM. The method may include identifying, at 1401 from another element of the cellular network, a context request that includes an inactive radio network temporary identifier (I-RNTI) related to a UE of the cellular network and context information related to the connection of the UE prior to entering an RRC_INACTIVE state; storing, at 1402, the I-RNTI and the context information; and providing, at 1403 based on a request related to an RRC resume procedure of the UE, an indication of the I-RNTI and the context information.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### 1. Example Implementations

Additional examples of the presently described methods, devices, systems, and networks discussed herein include the following, non-limiting implementations. Each of the following non-limiting examples may stand on its own or may be combined in any permutation or combination with any one or more of the other examples provided below or throughout the present disclosure.

Example 1 includes a method for UE's context management during the RRC release (going inactive with suspendConfig) and RRC resume procedures using a UE's context management function.

Example 2 includes the method of example 1 and/or some other example(s) herein, wherein the DU sends the RRCRelease to the UE with the suspendConfig and I-RNTI as the identifier to be used to store and fetch UE's context information in the UE's context management function.

Example 3 includes the method of example 1 and/or some other example(s) herein, wherein the DU stores the UE's context information to the UE's Context Management function together with the DU's ID and the I-RNTI.

Example 4 includes the method of example 1 and/or some other example(s) herein, wherein the DU sends the UE's context information to the RCM which further sends the UE's context information, the UE's I-RNTI as well as the DU ID to the UE's context management function.

Example 5 includes the method of example 1 and/or some other example(s) herein, wherein the RCM can reallocate the I-RNTI and sends to the DU that UE is connected to.

Example 6 includes the method of example 1 and/or some other example(s) herein, wherein the DU retrieves the UE's context information after it receives the RRC resume from the UE which includes the I-RNTI previously sent to the UE.

Example 7 includes the method of example 6 and/or some other example(s) herein, wherein the DU can sends the RRCResume message to the RCM which can alternatively retrieve UE's context information from the UE Context Management function.

Example 8 includes the method of example 6 and/or some other example(s) herein, wherein the I-RNTI can be allocated during the initial access or service request procedure by the RCM or AMF and stored as part of the context information in the DU as well as the UE Context Management function.

Example 9 includes a method, comprising: detecting a trigger for a user equipment (UE) to enter an RRC_INACTIVE state; and transmitting an RRC release message to the UE based on the trigger.

Example 10 includes the method of example 9 and/or some other example(s) herein, wherein the RRCRelease message includes an inactive radio network temporary identifier (I-RNTI) to be used to store and retrieve UE context information in a UE context management function (UCM).

Example 11 includes the method of example 10 and/or some other example(s) herein, wherein the I-RNTI is included in a suspension configuration (SuspendConfig) in the RRCRelease message.

Example 12 includes the method of examples 10-11 and/or some other example(s) herein, wherein the method includes: sending, to the UCM, a UE context update request including the I-RNTI, wherein the UE context update request is to cause the UCM to store the UE context information.

Example 13 includes the method of example 12 and/or some other example(s) herein, wherein the UE context update request includes a distributed unit (DU) identifier (ID), and the UE context update request is to cause the UCM to store the UE context information together with the DU ID and the I-RNTI.

Example 14 includes the method of examples 10-11 and/or some other example(s) herein, wherein the method includes: sending, to a RRC connection management function (RCM), UE context information including the I-RNTI, wherein the UE context information is to cause the RCM to store the UE context information in the UCM.

Example 15 includes the method of example 14 and/or some other example(s) herein, wherein the UE context information includes a DU ID, and the UE context information is to cause the RCM to store the UE context information together with the DU ID and the I-RNTI at the UCM.

Example 16 includes the method of examples 14-15 and/or some other example(s) herein, wherein the method includes: receiving, from the RCM, a new I-RNTI re-allocated to the UE.

Example 17 includes the method of examples 10-16 and/or some other example(s) herein, wherein the method includes: receiving, from the UE, a RRC resume message including the I-RNTI; and retrieving the UE context information based on the I-RNTI included in the RRC resume message.

Example 18 includes the method of examples 14-16 and/or some other example(s) herein, wherein the method includes: receiving, from the UE, a RRC resume message including the I-RNTI; and sending, to the RCM, the RRC resume message, wherein the RRC resume message is to cause the RCM to retrieve the UE context information from the UCM.

Example 19 includes the method of example 17 and/or some other example(s) herein, wherein the I-RNTI can be allocated during an initial access procedure or during a service request procedure by the RCM or by an access management function (AMF).

Example 20 includes the method of examples 9-19 and/or some other example(s) herein, wherein the method is performed by a distributed unit (DU) in a next generation radio access network (NG-RAN).

Example 21 may include a method to be performed by an element of a cellular network, wherein the method comprises: identifying occurrence of a condition that is to trigger a user equipment's (UE's) entrance into an RRC_INACTIVE state; causing transmission of an RRCRelease message to the UE based on the occurrence of the condition, wherein the RRCRelease message is to cause the UE to enter the RRC_INACTIVE state, and wherein the RRCRelease message includes an indication of an inactive radio network temporary identifier (I-RNTI) related to the UE; and transmitting, to a UE context management function of the cellular network, a context request that includes the I-RNTI and context information related to a connection of the UE prior to entering the RRC_INACTIVE state.

Example 22 may include the method of example 21, and/or one or more other examples herein, wherein a SuspendConfig information element (IE) of the RRCRelease message includes the indication of the I-RNTI related to the UE.

Example 23 may include the method of any one or more of examples 21-22, and/or one or more other examples herein, wherein the context request is a Nucm_UEContextUpdate request.

Example 24 may include the method of any one or more of examples 21-23, and/or one or more other examples herein, wherein the context information includes an identifier of a distributed unit (DU) that is wirelessly coupled with the UE.

Example 25 may include the method of any one or more of examples 21-24, and/or one or more other examples herein, wherein the context information includes a radio configuration of the UE.

Example 26 may include the method of any one or more of examples 21-25, and/or one or more other examples herein, wherein the element is a distributed unit (DU) of a base station of the cellular network.

Example 27 may include the method of any one or more of examples 21-25, and/or one or more other examples herein, wherein the element is a radio resource control (RRC) connection management function (RCM) of the cellular network.

Example 28 may include a method to be performed by a user equipment (UE) context management function of a cellular network, wherein the method comprises: identifying, from another element of the cellular network, a context request that includes an inactive radio network temporary identifier (I-RNTI) related to a UE of the cellular network and context information related to a connection of the UE prior to entering an RRC_INACTIVE state; storing the I-RNTI and the context information; and providing, based on a request related to an RRC resume procedure of the UE, an indication of the I-RNTI and the context information.

Example 29 may include the method of example 28, and/or one or more other examples herein, wherein the element is a distributed unit (DU) of a base station of the cellular network.

Example 30 may include the method of any one or more of examples 28-29, and/or one or more other examples herein, wherein the element is a radio resource control (RRC) connection management function (RCM) of the cellular network.

Example 31 may include the method of any one or more of examples 28-30, and/or one or more other examples herein, wherein the context request is a Nucm_UEContextUpdate request.

Example 32 may include the method of any one or more of examples 28-31, and/or one or more other examples herein, wherein the context information includes an identifier of a distributed unit (DU) that is wirelessly coupled with the UE.

Example 33 may include the method of any one or more of examples 28-32, and/or one or more other examples herein, wherein the context information includes a radio configuration of the UE.

Example 34 may include the method of any one or more of examples 28-33, and/or one or more other examples herein, wherein the request related to the RRC resume procedure of the UE is a Nucm_UEContextRetrieve request.

Example 35 may include the method of any one or more of examples 28-34, and/or one or more other examples herein, wherein the indication of the I-RNTI and the context information is provided in a Nucm_UEContextRetrieve response message.

Example Z01 includes one or more computer readable media comprising instructions, wherein execution of the instructions by processor circuitry is to cause the processor circuitry to perform the method of any one of examples 1-35.

Example Z02 includes a computer program comprising the instructions of example Z01.

Example Z03 includes an Application Programming Interface defining functions, methods, variables, data structures, and/or protocols for the computer program of example Z02.

Example Z04 includes an API or specification defining functions, methods, variables, data structures, protocols, and the like, defining or involving use of any of examples 1-35 or portions thereof, or otherwise related to any of examples 1-35 or portions thereof.

Example Z05 includes an apparatus comprising circuitry loaded with the instructions of example Z01.

Example Z06 includes an apparatus comprising circuitry operable to run the instructions of example Z01.

Example Z07 includes an integrated circuit comprising one or more of the processor circuitry of example Z01 and the one or more computer readable media of example Z01.

Example Z08 includes a computing system comprising the one or more computer readable media and the processor circuitry of example Z01.

Example Z09 includes an apparatus comprising means for executing the instructions of example Z01.

Example Z10 includes a signal generated as a result of executing the instructions of example Z01.

Example Z11 includes a data unit generated as a result of executing the instructions of example Z01.

Example Z12 includes the data unit of example Z10 and/or some other example(s) herein, wherein the data unit is a datagram, network packet, data frame, data segment, a Protocol Data Unit (PDU), a Service Data Unit (SDU), a message, or a database object.

Example Z13 includes a signal encoded with the data unit of examples Z11 and/or Z12.

Example Z14 includes an electromagnetic signal carrying the instructions of example Z01.

Example Z15 includes an apparatus comprising means for performing the method of any one of examples 1-35 and/or some other example(s) herein.

Example Z16 includes an edge compute node executing a service as part of one or more edge applications instantiated on virtualization infrastructure, the service being related to any of examples 1-35, portions thereof, and/or some other example(s) herein.

1. One or more electronic devices configured to implement an element of a cellular network, wherein the one or more electronic devices include:
memory to store information related to a condition that is to trigger a user equipment's (UE's) entrance into an RRC_INACTIVE state; and
one or more processors configured to:
identify occurrence of the condition;
cause transmission of an RRCRelease message to the UE based on the occurrence of the condition, wherein the RRCRelease message is to cause the UE to enter the RRC_INACTIVE state, and wherein the RRCRelease message includes an indication of an inactive radio network temporary identifier (I-RNTI) related to the UE; and
cause a context request to be transmitted to a UE context management function of the cellular network, wherein the context request includes the I-RNTI and context information related to a connection of the UE prior to entering the RRC_INACTIVE state.

2. The one or more electronic devices of claim 1, wherein a SuspendConfig information element (IE) of the RRCRelease message includes the indication of the I-RNTI related to the UE.

3. The one or more electronic devices of claim 1, wherein the context request is a Nucm_UEContextUpdate request.

4. The one or more electronic devices of claim 1, wherein the context information includes an identifier of a distributed unit (DU) that is wirelessly coupled with the UE.

5. The one or more electronic devices of claim 1, wherein the context information includes a radio configuration of the UE.

6. The one or more electronic devices of claim 1, wherein the element is a distributed unit (DU) of a base station of the cellular network.

7. The one or more electronic devices of claim 1, wherein the element is a radio resource control (RRC) connection management function (RCM) of the cellular network.

8. One or more non-transitory computer-readable media comprising instructions that, upon execution of the instructions by one or more processors of an electronic device, are to cause a user equipment (UE) context management function of a cellular network to:
identify, from another element of the cellular network, a context request that includes an inactive radio network temporary identifier (I-RNTI) related to a UE of the cellular network and context information related to a connection of the UE prior to entering an RRC_INACTIVE state;
store the I-RNTI and the context information; and
provide, based on a request related to an RRC resume procedure of the UE, an indication of the I-RNTI and the context information.

9. The one or more non-transitory computer-readable media of claim 8, wherein the element is a distributed unit (DU) of a base station of the cellular network.

10. The one or more non-transitory computer-readable media of claim 8, wherein the element is a radio resource control (RRC) connection management function (RCM) of the cellular network.

11. The one or more non-transitory computer-readable media of claim 8, wherein the context request is a Nucm_UEContextUpdate request.

12. The one or more non-transitory computer-readable media of claim 8, wherein the context information includes an identifier of a distributed unit (DU) that is wirelessly coupled with the UE.

13. The one or more non-transitory computer-readable media of claim 8, wherein the context information includes a radio configuration of the UE.

14. The one or more non-transitory computer-readable media of claim 8, wherein the request related to the RRC resume procedure of the UE is a Nucm_UEContextRetrieve request.

15. The one or more non-transitory computer-readable media of claim 8, wherein the indication of the I-RNTI and the context information is provided in a Nucm_UEContextRetrieve response message.

16. One or more non-transitory computer-readable media comprising instructions that, upon execution of the instructions by one or more processors of an electronic device, are to cause an element of the cellular network to:
identify occurrence of a condition that is to trigger a user equipment's (UE's) entrance into an RRC_INACTIVE state;
cause transmission of an RRCRelease message to the UE based on the occurrence of the condition, wherein the RRCRelease message is to cause the UE to enter the RRC_INACTIVE state, and wherein the RRCRelease message includes an indication of an inactive radio network temporary identifier (I-RNTI) related to the UE; and
cause a context request to be transmitted to a UE context management function of the cellular network, wherein the context request includes the I-RNTI and context information related to a connection of the UE prior to entering the RRC_INACTIVE state.

17. The one or more non-transitory computer-readable media of claim 16, wherein a SuspendConfig information element (IE) of the RRCRelease message includes the indication of the I-RNTI related to the UE.

18. The one or more non-transitory computer-readable media of claim 16, wherein the context request is a Nucm_UEContextUpdate request.

19. The one or more non-transitory computer-readable media of claim 16, wherein the context information includes an identifier of a distributed unit (DU) that is wirelessly coupled with the UE.

20. The one or more non-transitory computer-readable media of claim 16, wherein the context information includes a radio configuration of the UE.
